(19) United States
(12) Patent Application Publication
(10) Pub. No.: US 2008/0061591 A1
(43) Pub. Date: Mar. 13, 2008

(54) Folding Top

(75) Inventors: Mathias Froschle, Ostfildern (DE); Markus Schulzki, Ludwigsburg (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/852,534

(22) Filed: Sep. 10, 2007

(30) Foreign Application Priority Data
Sep. 8, 2006 (DE) DE 102006042286.4

(51) Int. Cl. B60J 7/14

(52) U.S. Cl. 296/108

(57) ABSTRACT

A folding top of a motor vehicle has two top bearings which are fixed on the vehicle body and on which a top linkage for the folding top is mounted such that it can be pivoted between a closed position of the top and a lowered position of the top. A pivotal rear window carrier is coupled to the top linkage in such a manner that it is raised when the folding top is closed and is lowered when the folding top is lowered. The top linkage is coupled, for the purpose of raising the rear window carrier, to front links mounted on the latter on both sides at the front, as seen in the direction of the front end of the vehicle. The rear window carrier is coupled on both sides to the top bearing by rear links, whereas the top linkage is coupled, for the purpose of displacing the rear window carrier, between the raised and lowered position, to one of the front links by in each case at least one coupling element.

### CROSS-REFERENCE TO RELATED APPLICATION

This application claims the priority, under 35 U.S.C. §119, of German application DE 10 2006 042 286.4, filed Sep. 8, 2006; the prior application is herewith incorporated by reference in its entirety.

### BACKGROUND OF THE INVENTION

### Field of the Invention

The invention relates to a folding top of a motor vehicle. The folding top has two top bearings which are fixed on a vehicle body and on which a top linkage for the folding top is mounted such that it can be pivoted between a closed position of the top and a lowered position of the top. A pivotal rear window carrier is coupled to the top linkage in such a manner that it is raised when the folding top is closed and is lowered when the folding top is lowered. The top linkage is coupled, for the purpose of raising the rear window carrier, to front links mounted on the latter on both sides at the front, as seen in a direction of a front end of the vehicle.

European patent EP 1 164 042 B1, corresponding to U.S. Pat. No. 6,536,831, discloses a motor vehicle folding top with a rear window carrier which is fastened rigidly to a clamping hoop of the folding top. The clamping hoop, with the rear window carrier fastened to it, is moved to and for by the top linkage of the folding top between a raised position, in which the clamping hoop sits on the top compartment lid of the vehicle body, and a lowered position, in which the clamping hoop, pivoted through more than 180°, is accommodated in the top compartment, when the folding top is closed and opened. In order to couple the folding top to the clamping hoop, a respective link which is coupled to the top linkage of the folding top is coupled on both sides of the rear frame.

German patent DE 100 41 487 B4, corresponding to U.S. Pat. No. 6,513,857, discloses a motor vehicle folding top with a clamping hoop on which the rear window is pivotally mounted. The rear window can be pivoted to and for between a raised position, in which it bears with its upper edge under prestress against a sealing device of the top linkage, and a lowered position, in which the rear window is lowered into the clamping hoop. In order to displace the rear window, the latter is provided on both sides with a respective toggle lever. When the rear window is raised, the toggle levers are moved beyond their dead center and thus securely support the rear window. To open the toggle levers, the joint of each toggle lever is coupled to the top linkage by a cable or a Bowden cable in such a manner that the toggle levers are moved away from their dead center positions and folded up during opening of the folding top.

### SUMMARY OF THE INVENTION

It is accordingly an object of the invention to provide a folding top which overcomes the above-mentioned disadvantages of the prior art devices of this general type, in which the rear window carrier, in particular coupled in a simple manner to the top linkage, is put away and erected.

With the foregoing and other objects in view there is provided, in accordance with the invention, a folding top for a motor vehicle. The folding top contains two top bearings fixed on a vehicle body and a top linkage mounted on the top bearings such that the top linkage can be pivoted between a closed position of the folding top and a lowered position of the folding top. The folding top further has front links, rear links, coupling elements, and a pivotal rear window carrier coupled to the top linkage such that the pivotal rear window carrier is raised when the folding top is closed and is lowered when the folding top is lowered. The top linkage is coupled, for raising the pivotal rear window carrier, to the front links mounted on the pivotal rear window carrier on both sides at a front, as seen in a direction of a front end of the motor vehicle. The pivotal rear window carrier is further coupled on both sides to the top bearing by the rear links. The top linkage is coupled, for displacing the pivotal rear window carrier, between a raised position and a lowered position, to one of the front links by in each case one of the coupling elements.

In the case of the folding top according to the invention, the rear window carrier is mounted pivotally by use of the front links and at the same time by use of rear links, i.e. links disposed behind the front links as seen from the direction of the front end of the vehicle, with the rear links, for their part, being mounted pivotally on the top bearing of the top linkage. This type of mounting results in a defined putting-away and erecting movement of the rear window carrier, the putting-away and erecting movement of the rear window carrier being coordinated with the closing and opening of the folding top in a simple manner by the coupling of the front links to the top linkage.

In this context, the folding top is understood as meaning a top in which at least some roof sections are manufactured from a foldable material, for example a fabric, which is kept in the desired shape with the aid of the top linkage. Individual roof sections can also have a fixed, in particular, shell-like configuration, the shell or parts thereof being composed of metal, plastic or else of glass or another transparent material. The rear window carrier is understood as meaning a supporting structure, for example in the form of a frame which is opened or closed on at least one side and in which the rear window, preferably configured as a fixed glass window, is held securely and, in particular, in a manner largely free of vibration. Furthermore, the term rear window carrier is also to be understood as meaning a configuration of a plurality of carrier elements which are connected fixedly to the rear window and to which the front and rear links are coupled.

It is advantageous, in particular, to connect the rear window carrier fixedly to the folding top. The connection of the rear window carrier to the folding top enables the material of the top, for its part, to act as a type of elastic link by which the putting-away and erecting behavior of the rear window carrier can additionally be influenced in a specific manner, the rear window carrier, given an appropriate configuration of the top linkage, being held in a defined manner in its raised position, for example by corresponding transverse bows, if appropriate also by the material of the top. However, as an alternative, it is also possible to form the rear window carrier separately from the material of the top and, on the top linkage, to provide corresponding sealing elements against which the rear window carrier is prestressed when it is moved into its raised position.

In a particularly preferred embodiment of the folding top according to the invention, it is proposed that each front link has two link levers which are connected to each other in an articulated manner and via which the rear window carrier is coupled to the two top bearings. The two link levers which are connected to each other are preferably configured here in such a manner that they form a toggle lever which is located in its dead center in a raised position of the rear window carrier, and therefore the link levers only fold up again by a corresponding application of force to the joint. At the same time, the rear window carrier is supported securely on the two top bearings.

In this preferred embodiment, it is furthermore proposed, as the coupling element for each of the front links formed from two link levers in each case, to use a control lever which is mounted pivotally on the top linkage and with which the two-part front link assigned in each case to the control lever can be released and folded up during a movement of the top linkage. In this case, the control lever at the same time prevents an unintentional folding up of the two-part front link with which the control lever interacts.

The control lever, preferably spaced apart from the joint between the two link levers, is connected pivotally to one of the link levers, preferably by a joint, and therefore the link lever coupled to the control lever is held securely in a defined position. Preferably, the control lever is connected pivotally to the lower of the two link levers, which is coupled to the top bearing, since, by this measure, the folding top can be collapsed without interference as it is being lowered.

In a second embodiment of the folding top according to the invention, each coupling element is a control extension which is connected fixedly to the top linkage and to which the front link assigned in each case to the control extension is directly coupled. By this direct connection of the front links to the top linkage, the number of required coupling points and therefore the number of required components is very low, thus resulting, in particular, in a simple construction of the folding top. In the second embodiment, it is also advantageous, in particular, if the material of the folding top is connected fixedly to the rear window carrier, since the putting-away and raising movement of the rear window carrier is thereby influenced in a specific manner.

In order to fasten and drive the folding top, the top linkage on each side of the folding top preferably has two top links which form a four-bar linkage and support and drive the folding top, the two control links with which the rear window carrier is coupled to the top linkage being provided on in each case one of the two top links which form the four-bar linkage. It is thus advantageous if the coupling elements configured as control levers are coupled to the front of the two top links in each case, since the front top links, which usually form the B pillar when the folding top is closed, are of correspondingly stiff construction. In general, however, it is also conceivable to couple the control levers to the two rear top links.

In order to dimension the connection between the top linkage and the front links to be as short as possible, in the embodiment in which the front links of the rear window are not supported on the top bearings but rather are coupled to the control extensions of the top linkage, it is proposed to provide the coupling elements configured as the control extension on the rear of the two top links in each case.

Other features which are considered as characteristic for the invention are set forth in the appended claims.

Although the invention is illustrated and described herein as embodied in a folding top, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side view of a folding top in a closed position with a first exemplary embodiment of a lowerable rear window according to the invention;

FIG. 2 is a diagrammatic, side view of the folding top according to FIG. 1 in an intermediate position during a starting of the lowering of the folding top;

FIG. 3 is diagrammatic, side view of the folding top according to FIG. 1 in its lowered position with a lowered rear window;

FIG. 4 is a diagrammatic, side view of the folding top in the closed position, which is equipped with a second exemplary embodiment of a lowerable rear window according to the invention;

FIG. 5 is a diagrammatic, side view of the folding top according to FIG. 4 in an intermediate position during the lowering of the folding top; and

FIG. 6 is a diagrammatic, side view of the folding top according to FIG. 4 in its lowered position with lowered rear window.

### DETAILED DESCRIPTION OF THE INVENTION

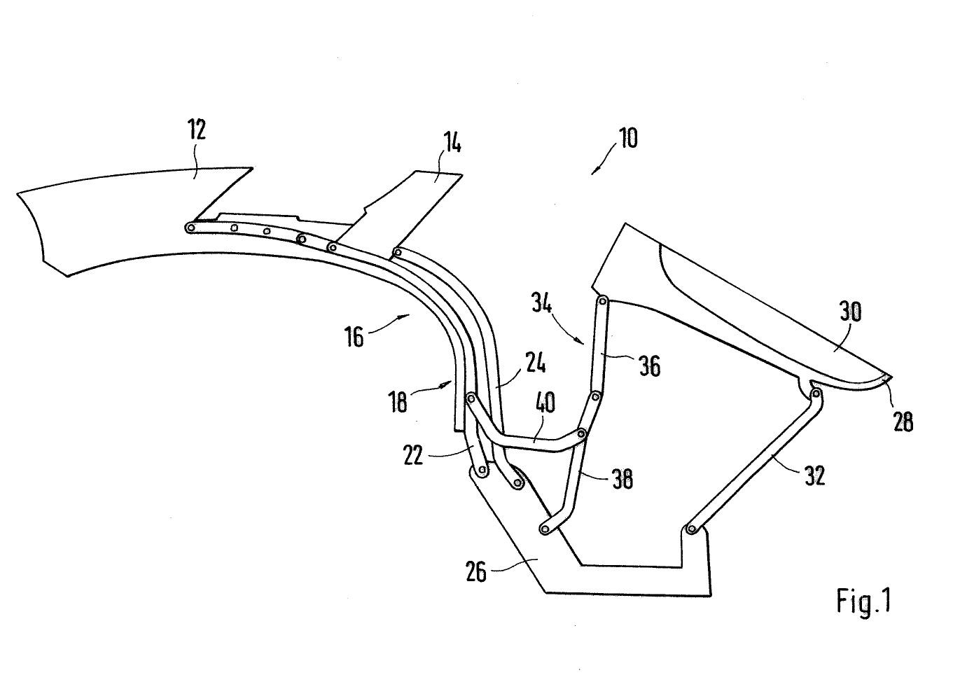

Referring now to the figures of the drawing in detail and first, particularly, to FIGS. 1-3 thereof, there is shown a diagrammatic, side view of a vehicle with a folding top 10.

As illustrated in particular in FIG. 1, in which the folding top 10 is shown in a closed position of the top, the folding top 10 has a front first roof frame 12 and a central roof frame 14. The two roof frames 12 and 14 are coupled movably to each other by a top linkage 16 in such a manner that, during the closing and opening, the first roof frame 12 is moved away over the second roof frame 14. For this purpose, on each of the two side edges of the roof frames 12 and 14, a roof link configuration 18 containing a plurality of roof links 20 connected to one another in an articulated manner is provided, a plurality of which roof links are also fastened pivotally to the respective side edge of at least one of the roof frames 12 and 14.

Each of the two roof link configurations 18 on both sides of the roof frames 12 and 14 is coupled to two top links 22 and 24 which are each mounted pivotally on one of the two top bearings 26 fixed on the vehicle body. The top links 22 and 24 are coupled to the second roof frame 14 and support the latter together with the first roof frame 12. At the same time, the two top links 22 and 24 serve to drive and displace the roof links 20 during the closing and opening of the folding top 10.

The rear end of the folding top 10 is formed by a rear window carrier 28. The rear window carrier 28 supports a fixed glass window 30 which is held in the rear window carrier 28 by a non-illustrated sealing element. The rear window carrier 28 is mounted pivotally at the free ends of two rear links 32 which are disposed in the vicinity of the rear of the vehicle and the other ends of which are mounted on the top bearings 26, which are extended for this purpose. In front of the rear links 32, as seen from the direction of the front end of the vehicle, two front links 34 are coupled to the rear window carrier 28, the two front links 34 each being formed as toggle levers containing two link levers 36 and 38 connected to each other in an articulated manner. The lower of the two link levers 38 of each front link 34 is likewise mounted on the top bearing 26.

In order for the rear window carrier 28 to move in accordance with the adjustment movement of the folding top 10 during the closing or opening thereof, the rear window carrier 28 is coupled to the top linkage 16. For this purpose, a respective control lever 40 is coupled at its one end to each of the two front top links 22 while the other end of each control lever 40 is coupled to the respectively lower link lever 38 of the front link 34.

When the folding top 10 is closed, as shown in FIG. 1, the two link levers 36 and 38 run in an extended manner with respect to each other such that they are in a dead center position in which the link levers 36 and 38 only move out of the dead center positions by the application of an external force acting in the folding direction. The interaction of the control lever 40 with the link levers 36 and 38 thus prevents the front links 34 from folding up, and therefore the rear window carrier 28 can be supported on the top bearings 26 via the front links 34 and the rear links 32 and is thereby held in a defined position with respect to the vehicle.

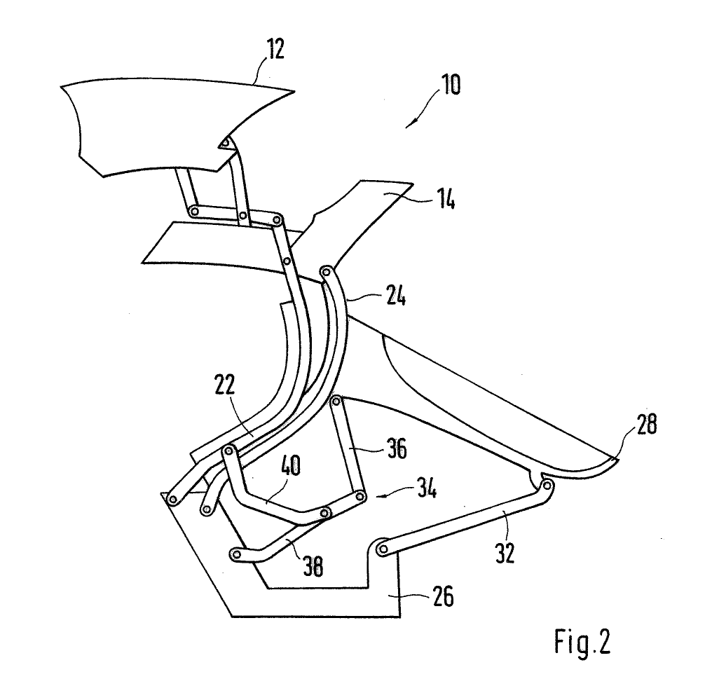

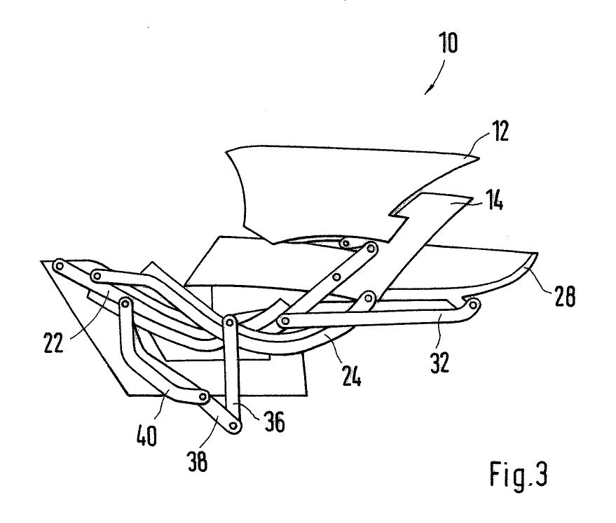

If the folding top 10 is now moved from its closed position of the top into its lowered position of the top, this operation is shown in FIGS. 2 and 3, the two top links 22 and 24 on each side of the folding top 10, by means of their coupling to the roof link configurations 18 of the two roof sections 12 and 14, bring about an approximately parallel movement of the two roof sections 12 and 14 one above the other. At the same time, the two control levers 40 cause the front link levers 36 and 38, which are connected to each other in an articulated manner, to be moved out of their dead center positions in which they have held the rear window carrier 28 in a raised manner. By the interaction of the front links 34 with the top links 22 and the interaction of the front links 34 with the rear links 32, the rear window carrier 28 carries out a defined putting-away movement, which can be seen from FIGS. 2 and 3, in accordance with the movement of the top linkage 16.

After the folding top 10 has been fully lowered, the rear window carrier 28 is positioned in a protected manner under the further roof frames 12 and 14 (see FIG. 3), the individual links of the top linkage 16 and of the rear window carrier 28 being collapsed, thus resulting in a minimum required volume for the collapsed folding top 10.

During the unfolding of the folding top 10, the top links 22 and 24 drive the roof link configurations 18 and the front links 34 in the reverse sequence, as a result of which the folding roof 10 is spread out again and the rear window carrier 28 is moved again into its raised position.

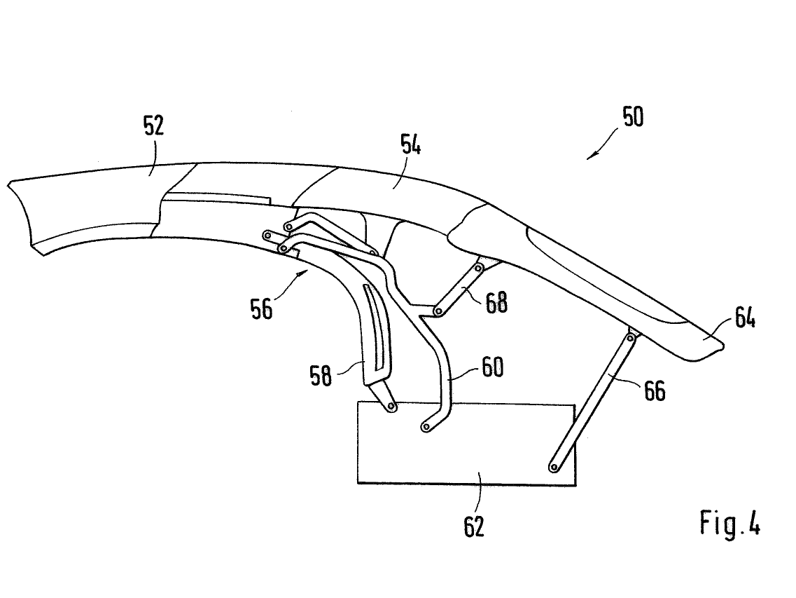

FIGS. 4 to 6 show a second exemplary embodiment of a folding top 50. The construction of the folding top 50 generally corresponds to the construction of the folding top 10.

As in particular FIG. 4 shows, the folding top 50 likewise has two roof frames 52 and 54 which are supported at their side edges by a top linkage 56. For this purpose, the top linkage 56 has two roof link configurations 56 which, for their part, are driven and supported by two top links 58 and 60 disposed as a four-bar linkage on each side of the folding top 50. In the second exemplary embodiment too, the two top links 58 and 60 are mounted pivotally on top bearings 62 fixed on the vehicle body.

The rear window carrier 64 is mounted pivotally on the two top bearings 62 by two rear links 66. Furthermore, the rear window carrier 64 has, on its lower side, two front links 68 which are coupled pivotally to the rear window carrier 64. Each of the front links 68 is coupled to a control extension 70 which protrudes to the rear approximately at right angles in the direction of the vehicle rear from the respective rear top link 60. Furthermore, the material 72 of the folding top 50 is connected fixedly to the front edge of the rear window carrier 64.

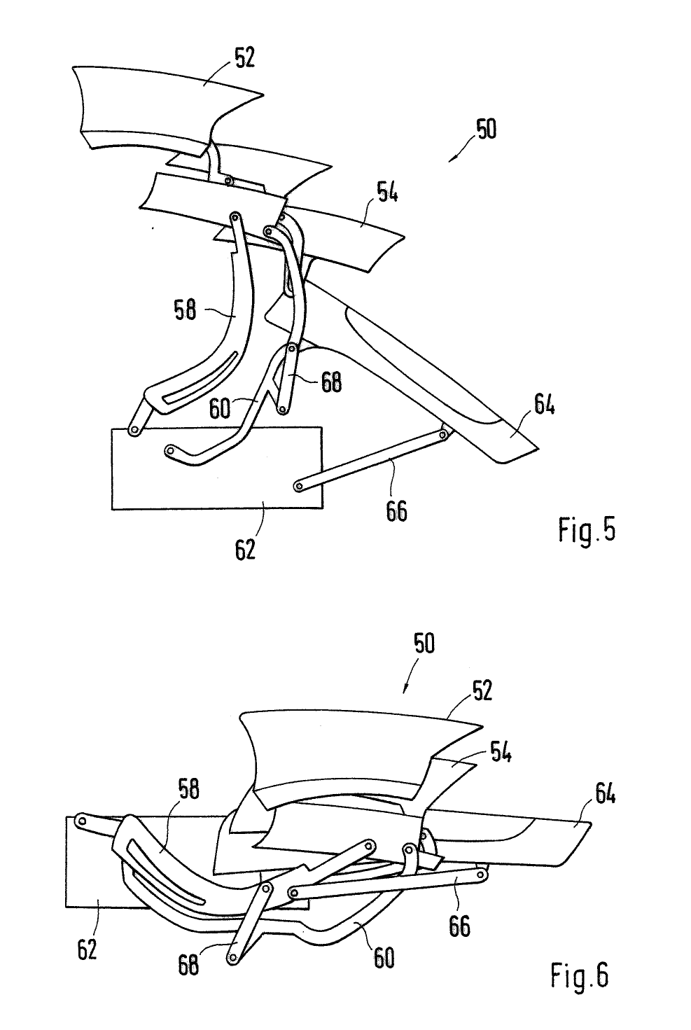

If the folding top 50 is now moved from its closed position shown in FIG. 4, this operation is shown schematically in FIGS. 5 and 6, in this case too the roof frames 52 and 54 are moved relative to each other and one above the other while at the same time the rear top links 60, via the control extensions 70, fold the front links 68 of the rear window carrier 64 over to the rear in the direction of the vehicle rear and at the same time press the rear window carrier 64 to the rear, the latter carrying out a pivoting and lowering movement by means of the rear link 66 coupled to it.

After the folding top 50 is fully collapsed, in this case too the rear window carrier 64 is disposed in a protected manner under the two roof frames 52 and 54.

During the unfolding of the folding top 50, the roof frames 52 and 54 and the rear window carrier 64 carry out the previously described sequence of movement in the reverse sequence until the folding top 50 again takes up its closed position shown in FIG. 4.

1. A folding top for a motor vehicle, the folding top comprising:
two top bearings fixed on a vehicle body;
a top linkage mounted on said top bearings such that said top linkage can be pivoted between a closed position of the folding top and a lowered position of the folding top;
front links;
rear links;
coupling elements; and
a pivotal rear window carrier coupled to said top linkage such that said pivotal rear window carrier is raised when the folding top is closed and is lowered when the folding top is lowered, said top linkage being coupled, for raising said pivotal rear window carrier, to said front links mounted on said pivotal rear window carrier on both sides at a front, as seen in a direction of a front end of the motor vehicle, said pivotal rear window carrier being coupled on both sides to said top bearing by said rear links, and said top linkage being coupled, for displacing said pivotal rear window carrier, between a raised position and a lowered position, to one of said front links by in each case one of said coupling elements.

2. The folding top according to claim 1, wherein said pivotal rear window carrier is connected fixedly to the folding top.

3. The folding top according to claim 1, wherein each of said front links has two link levers which are connected to each other in an articulated manner and via which said pivotal rear window carrier is coupled to said two top bearings.

4. The folding top according to claim 3, wherein said coupling elements are each a control lever mounted pivotally on said top linkage and coupled to said front links having said two link levers.

5. The folding top according to claim 4, wherein said control lever, assigned to said respective front link and spaced apart from a joint between said two link levers, is connected pivotally to one of said two link levers.

6. The folding top according to claim 1, wherein:
each of said coupling elements is a control extension connected fixedly to said top linkage; and
said respective front link assigned in each case to said control extension is directly coupled to said top linkage.

7. The folding top according to claim 1, wherein said top linkage has two top links which form a four-bar linkage and support the folding top, each of said coupling elements being provided on in each case one of said two top links forming said four-bar linkage.

8. The folding top according to claim 7, wherein said coupling elements are control levers coupled to a front of said two top links in each case.

9. The folding top according to claim 7, wherein said coupling elements are control extensions disposed on a rear of said two top links in each case.

10. The folding top according to claim 5, wherein said two link levers include a lower link lever coupled to said top bearing and an upper link lever, said control lever is connected pivotally to said lower link lever.

11. A motor vehicle, comprising:
a transmission;
at least one driver axle;
an internal combustion engine driving said at least one axle via said transmission; and
a folding top containing:
two top bearings fixed on a vehicle body;
a top linkage mounted on said top bearings such that said top linkage can be pivoted between a closed position of the folding top and a lowered position of the folding top;
front links;
rear links;
coupling elements; and
a pivotal rear window carrier coupled to said top linkage such that said pivotal rear window carrier is raised when the folding top is closed and is lowered when the folding top is lowered, said top linkage being coupled, for raising said rear window carrier, to said front links mounted on said pivotal rear window carrier on both sides at a front, as seen in a direction of a front end of the motor vehicle, said pivotal rear window carrier being coupled on both sides to said top bearing by said rear links, and said top linkage being coupled, for displacing said pivotal rear window carrier, between a raised position and a lowered position, to one of said front links by in each case at least one of said coupling elements.
